(19) United States
(12) Patent Application Publication
(10) Pub. No.: US 2024/0278373 A1
(43) Pub. Date: Aug. 22, 2024

(54) MACHINE TOOL SYSTEM, OPERATION METHOD OF MACHINE TOOL SYSTEM, AND DETECTING SYSTEM FOR DETECTING LEVEL OF MACHINING FLUID TO BE SUPPLIED TO MACHINE TOOL

(71) Applicant: YI-DA PRECISION MACHINERY CO., LTD., Taichung City (TW)

(72) Inventor: Hung-Yu KAO, Taichung City (TW)

(21) Appl. No.: 18/476,889

(22) Filed: Sep. 28, 2023

(30) Foreign Application Priority Data
Feb. 22, 2023 (TW) 112106538

(51) Int. Cl. B23Q 11/10; B23Q 11/00

(52) U.S. Cl. CPC B23Q 11/1053; B23Q 11/0057; B23Q 11/1069

(57) ABSTRACT

A detecting system includes a tank unit, a pump and a controller. The tank unit includes a tank and an ultrasonic sensor. The tank stores machining fluid. The ultrasonic sensor is disposed on the tank, and measures a distance to a surface of the machining fluid stored in the tank and outputs a distance signal based on measurement of the distance. The pump is disposed on the tank, is connected to a nozzle of a machine tool, and pumps the machining fluid from the tank to the nozzle for spraying the machining fluid on a workpiece. The controller is connected to the machine tool, the ultrasonic sensor and the pump, and receives the distance signal, performs a liquid-level analysis based on the distance signal, and outputs to the machine tool a result of the liquid-level analysis.

### CROSS-REFERENCE TO RELATED APPLICATION

This application claims priority to Taiwanese Invention Patent Application No. 112106538, filed on Feb. 22, 2023, and incorporated by reference herein in its entirety.

### FIELD

The disclosure relates to a machine tool system, an operation method of a machine tool system, and a detecting system for detecting a level of machining fluid to be supplied to a machine tool.

### BACKGROUND

Conventionally, a machine tool pumps machining fluid from a tank to a nozzle for spraying the machining fluid on a workpiece when the machine tool is machining the workpiece, so as to remove chips from the workpiece and to reduce the temperature of the workpiece. Since supply of the machining fluid affects the machining of the workpiece, a sufficient amount of the machining fluid should be stored in the tank to ensure that machining quality is maintained.

### SUMMARY

Therefore, an object of the disclosure is to provide a machine tool system, an operation method of a machine tool system, and a detecting system for detecting a level of machining fluid to be supplied to a machine tool.

According to a first aspect of the disclosure, the machine tool is used to machine a workpiece and includes a nozzle. The detecting system includes a tank unit, a pump and a controller. The tank unit includes a tank and an ultrasonic sensor. The tank is configured to store machining fluid. The ultrasonic sensor is disposed on the tank, and is configured to measure a distance to a surface of the machining fluid stored in the tank and to output a distance signal based on measurement of the distance. The pump is disposed on the tank, is adapted to be connected to the nozzle, and is configured to pump the machining fluid from the tank to the nozzle for spraying the machining fluid on the workpiece. The controller is electrically connected to the machine tool, the ultrasonic sensor and the pump. The controller is configured to receive the distance signal, to perform a liquid-level analysis based on the distance signal, and to output to the machine tool a result of the liquid-level analysis that includes a level of the machining fluid stored in the tank.

According to a second aspect of the disclosure, the machine tool system includes a tank unit, a machine tool, a pump and a controller. The tank unit includes a tank and an ultrasonic sensor. The tank is configured to store machining fluid. The ultrasonic sensor is disposed on the tank, and is configured to measure a distance to a surface of the machining fluid stored in the tank, and to output a distance signal based on measurement of the distance. The machine tool is configured to machine a workpiece, and includes a nozzle that is configured to spray the machining fluid on the workpiece. The pump is disposed on the tank, is connected to the nozzle, and is configured to pump the machining fluid from the tank to the nozzle for spraying the machining fluid on the workpiece. The controller is electrically connected to the machine tool, the ultrasonic sensor and the pump. The controller is configured to receive the distance signal from the ultrasonic sensor, to perform a liquid-level analysis based on the distance signal, and to output to the machine tool a result of the liquid-level analysis that includes a level of the machining fluid stored in the tank. The machine tool is configured to determine whether the level of the machining fluid stored in the tank is less than a predetermined level, and to stop the pump when it has determined that the level of the machining fluid stored in the tank is less than the predetermined level.

According to a third aspect of the disclosure, the machine tool system includes a machine tool for machining a workpiece. The machine tool includes a nozzle, a tank storing machining fluid, an ultrasonic sensor disposed on the tank, a first thermometer disposed in the tank, a second thermometer disposed on the tank, a pump disposed on the tank for pumping the machining fluid from the tank to the nozzle for spraying the machining fluid on the workpiece, a chip remover for removing chips from the tank, and a controller that is electrically connected to the machine tool, the chip remover, the ultrasonic sensor, the first thermometer, the second thermometer and the pump. The method includes a pump-current-related scheme, a remover-current-related scheme, a liquid-level-related scheme, a liquid-temperature-related scheme and an environment-temperature-related scheme.

The pump-current-related scheme includes steps of: the controller performing pump-current detection on three-phase electric power received by the pump, and outputting to the machine tool a result of the pump-current detection that indicates a current value of the three-phase electric power received by the pump.

The remover-current-related scheme includes steps of: the controller performing remover-current detection on three-phase electric power received by the chip remover, and outputting to the machine tool a result of the remover-current detection that indicates a current value of the three-phase electric power received by the chip remover.

The liquid-level-related scheme includes steps of: the ultrasonic sensor measuring a distance to a surface of the machining fluid stored in the tank, and outputting a distance signal based on measurement of the distance; and the controller receiving the distance signal from the ultrasonic sensor, performing a liquid-level analysis based on the distance signal, and outputting to the machine tool a result of the liquid-level analysis that includes a level of the machining fluid stored in the tank.

The liquid-temperature-related scheme including steps of: the first thermometer detecting a temperature of the machining fluid stored in the tank, and outputting to the controller a liquid-temperature signal based on detection of the temperature of the machining fluid; and the controller performing a liquid-temperature analysis based on the liquid-temperature signal, and outputting to the machine tool a result of the liquid-temperature analysis that indicates the temperature of the machining fluid stored in the liquid tank.

The environment-temperature-related scheme including steps of: the second thermometer detecting a temperature of environment around the tank, and outputting to the controller an environment-temperature signal based on detection of the temperature of environment around the tank; and the controller performing an environment-temperature analysis based on the environment-temperature signal, and outputting to the machine tool a result of the environment-temperature analysis that indicates the temperature of environment around the liquid tank.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a schematic diagram illustrating a machine tool system according to an embodiment of the disclosure.

FIG. 2 is a flow chart of a first procedure of an operation method of the machine tool system according to an embodiment of the disclosure.

FIG. 3 is a flow chart of a second procedure of the operation method of the machine tool system according to an embodiment of the disclosure.

FIG. 4 is a flow chart of a third procedure of the operation method of the machine tool system according to an embodiment of the disclosure.

FIG. 5 is a flow chart of a fourth procedure of the operation method of the machine tool system according to an embodiment of the disclosure.

FIG. 6 is a block diagram of the machine tool system according to an embodiment of the disclosure.

### DETAILED DESCRIPTION

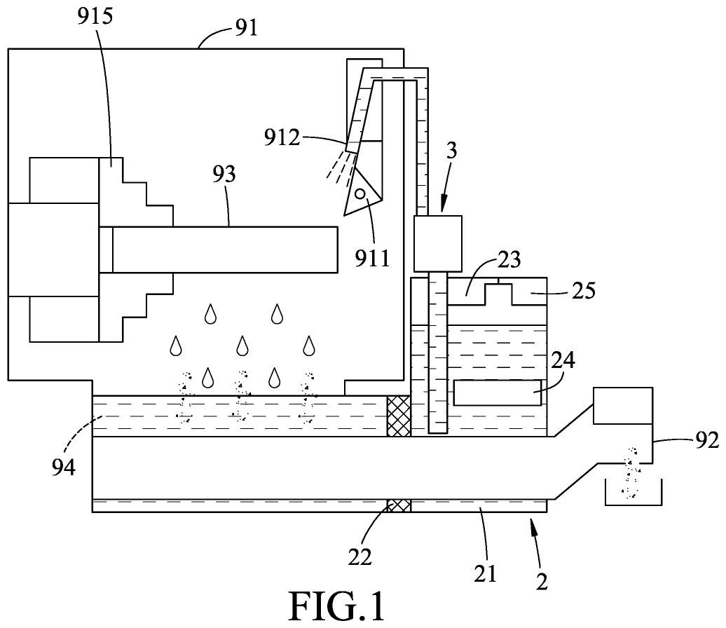

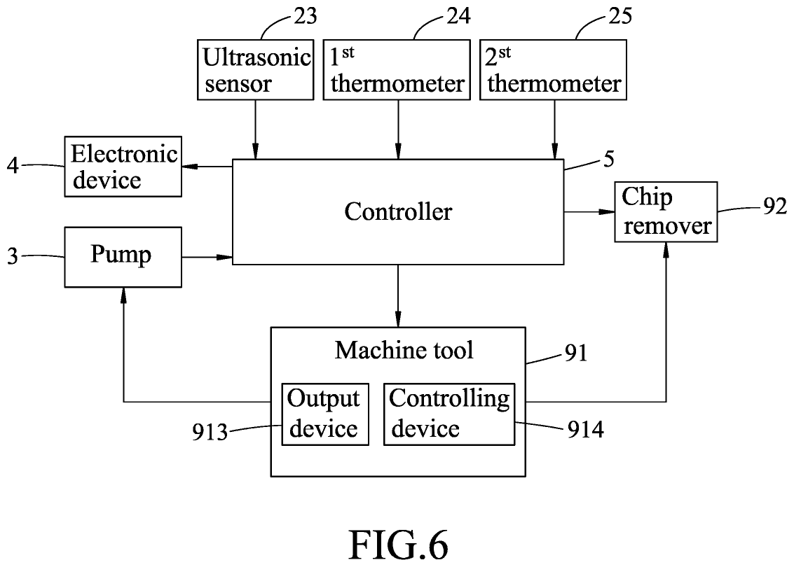

Referring to FIGS. 1 and 6, an embodiment of a machine tool system according to the disclosure is illustrated. The machine tool system includes a machine tool 91, a detecting system and a chip remover 92. The detecting system is adapted to cooperate with the machine tool 91 and the chip remover 92.

The machine tool 91 is used to machine a workpiece 93. Specifically, the machine tool 91 includes a nozzle 912, a clamping device 915 (e.g., a chuck) for holding the workpiece 93, and a machining component 911 for machining the workpiece 93. The machine tool 91 may be implemented by a computerized numerical control (CNC) machine tool, but is not limited thereto. The machining component 911 may be implemented by a cutter, a hob, and so on.

The detecting system is used for detecting a level of machining fluid 94 to be supplied to the machine tool 91, and includes a tank unit 2, a pump 3 and a controller 5.

The tank unit 2 includes a tank 21 and a filter 22. The tank 21 is positioned below the clamping device 915 of the machine tool 91, and is configured to store the machining fluid 94. The filter 22 is disposed in the tank 21.

The pump 3 is disposed on the tank 21, and is fluidly connected to the nozzle 912. The pump 3 is configured to pump the machining fluid 94 from the tank 21 to the nozzle 912 for spraying the machining fluid 94 on the workpiece 93. The filter 22 is configured to separate, from the machining fluid 94, chips that result from machining the workpiece 93 and that are brought down to the tank 21 by the machining fluid 94 sprayed on the workpiece 93. Additionally, the chip remover 92 is used for removing chips from the tank 21. After the machining fluid 94 has been cleaned by removing chips therefrom, the machining fluid 94 would be subsequently pumped from the tank 21 to the nozzle 912 by the pump 3. It is worth to note that in this embodiment, the chip remover 92 includes a three-phase motor (not shown) that runs with three-phase electric power, and the chip remover 92 removes chips from the tank 21 by using a conveyor to carry the chips out from the tank 21. Since the chip remover 92 is well-known in the art, details thereof will be omitted hereinafter for the sake of brevity.

The controller 5 may be implemented by a processor, a central processing unit (CPU), a microprocessor, a micro control unit (MCU), a system on a chip (SoC), or any circuit configurable/programmable in a software manner and/or hardware manner to implement functionalities discussed in this disclosure. The controller 5 is electrically connected to the machine tool 91, the pump 3 and the chip remover 92. In this embodiment, the controller 5 is a PIC18F microcontroller produced by Microchip Technology®, and communication between the controller 5 and the machine tool 91 follows a Modbus communication protocol.

The machine tool 91 is electrically connected to the pump 3 and the chip remover 92. The machine tool 91 further includes an output device 913 and a controlling device 914. The output device 913 may be a liquid-crystal display (LCD), a light-emitting diode (LED) display, a plasma display panel, a projection display or the like. However, implementation of the output device 913 is not limited to the disclosure herein and may vary in other embodiments. The controlling device 914 may be implemented by a computer including a processor, a CPU, a MCU, an SOC, or any circuit configurable/programmable in a software manner and/or hardware manner to implement functionalities discussed in this disclosure. The controlling device 914 is configured to control the pump 3 and the chip remover 92 (e.g., to stop the pump 3 and the chip remover 92 by cutting off electricity supply thereto).

The tank unit 2 further includes an ultrasonic sensor 23, a first thermometer 24 and a second thermometer 25.

The ultrasonic sensor 23 is disposed on the tank 21, and is electrically connected to the controller 5. The ultrasonic sensor 23 is configured to measure a distance to a surface of the machining fluid 94 stored in the tank 21 and to output a distance signal to the controller 5 based on measurement of the distance. The controller 5 is configured to receive the distance signal, to perform a liquid-level analysis based on the distance signal, and to output to the machine tool 91 a result of the liquid-level analysis. It is worth to note that the result of the liquid-level analysis includes a level of the machining fluid 94 stored in the tank 21, and the distance between the ultrasonic sensor 23 and the surface of the machining fluid 94 stored in the tank 21.

In response to receiving the result of the liquid-level analysis, the machine tool 91 is configured to determine whether the level of the machining fluid 94 stored in the tank 21 is less than a predetermined level, and to stop the pump 3 when determining that the level of the machining fluid 94 stored in the tank 21 is less than the predetermined level. In addition, the output device 913 is configured to express the level of the machining fluid 94 stored in the tank 21.

In particular, the machine tool 91 is further configured to determine, according to the distance between the ultrasonic sensor 23 and the surface of the machining fluid 94 stored in the tank 21 included in the result of the liquid-level analysis, whether the machining fluid 94 stored in the tank 21 is at a high liquid level, a medium liquid level, a low liquid level or a zero liquid level. In this embodiment, the high liquid level corresponds to a range of liquid levels each exceeding 75% of a height of the tank 21; the medium liquid level corresponds to a range of liquid levels each exceeding 50% of the height of the tank 21 but not exceeding 75% of the height of the tank 21; the low liquid level corresponds to a range of liquid levels each exceeding 25% of the height of the tank 21 but not exceeding 50% of the height of the tank 21; the zero liquid level corresponds to a range of liquid levels each exceeding 0% of the height of the tank 21 but not exceeding 25% of the height of the tank 21. In a case where the height of the tank 21 is 240 mm, the machine tool 91 is configured to determine that the machining fluid 94 stored in the tank 21 is at the high liquid level when determining that the distance between the ultrasonic sensor 23 and the surface of the machining fluid 94 stored in the tank 21 is less than 60 mm, at the medium liquid level when determining that the distance is not less than 60 mm but less than 120 mm, at the low liquid level when determining that the distance is not less than 120 mm but less than 180 mm, and at the zero liquid level when determining that the distance is not less than 180 mm. When it is determined that the machining fluid 94 stored in the tank 21 is at the zero liquid level, the output device 913 is configured to express a zero-liquid-level indication indicating that the machining fluid 94 stored in the tank 21 is at the zero liquid level. When it is determined that the machining fluid 94 stored in the tank 21 is at the low liquid level, the output device 913 is configured to express a low-liquid-level indication indicating that the machining fluid 94 stored in the tank 21 is at the low liquid level. When it is determined that the machining fluid 94 stored in the tank 21 is at the medium liquid level, the output device 913 is configured to express a medium-liquid-level indication indicating that the machining fluid 94 stored in the tank 21 is at the medium liquid level. When it is determined that the machining fluid 94 stored in the tank 21 is at the high liquid level, the output device 913 is configured to express a high-liquid-level indication indicating that the machining fluid 94 stored in the tank 21 is at the high liquid level. The machine tool 91 is configured to stop the pump 3 when it is determined that the machining fluid 94 stored in the tank 21 is at the low liquid level or the zero liquid level.

In one embodiment, upon activating the pump 3, the machine tool 91 is configured to time a preset time period (e.g., four minutes) and to determine an initial level of the machining fluid 94 stored in the tank 21. Then, the machine tool 91 is configured to determine whether a final level of the machining fluid 94 stored in the tank 21 reaches a preset level threshold as the preset time period has elapsed. When it is determined that the final level of the machining fluid 94 stored in the tank 21 does not reach the preset level threshold as the preset time period has elapsed, the output device 913 is configured to express an abnormal-level indication indicating that a rate of cycling the machining fluid 94 into the tank 21 is abnormal. At the same time, the machine tool 91 is further configured to determine whether the final level of the machining fluid 94 stored in the tank 21 is less than the initial level of the machining fluid 94 stored in the tank 21 by a preset level-difference threshold (e.g., 15% of the height of the tank 21), and to increase an abnormal counter (which is an integer and has an initial value of zero) by one when it is determined that the final level of the machining fluid 94 stored in the tank 21 is less than the initial level of the machining fluid 94 stored in the tank 21 by the preset level-difference threshold. The machine tool 91 is further configured to determine whether the abnormal counter is not less than a preset number (e.g., four). When it is determined that the abnormal counter is not less than the preset number, the output device 913 is configured to express a blocked-filter indication indicating that the filter 22 has been blocked.

The first thermometer 24 is disposed in the tank 21, and is electrically connected to the controller 5. The first thermometer 24 is configured to detect a temperature of the machining fluid 94 stored in the tank 21, and to output to the controller 5 a liquid-temperature signal based on detection of the temperature of the machining fluid 94. The controller 5 is further configured to perform a liquid-temperature analysis based on the liquid-temperature signal, and to output to the machine tool 91 a result of the liquid-temperature analysis that indicates the temperature of the machining fluid 94 stored in the tank 21. After the machine tool 91 receives the result of the liquid-temperature analysis, the output device 913 is configured to express the temperature of the machining fluid 94 stored in the tank 21.

The second thermometer 25 is disposed on said tank 21, and is electrically connected to the controller 5. The second thermometer 25 is configured to detect a temperature of environment outside and around the tank 21, and to output an environment-temperature signal to the controller 5 based on detection of the temperature of the environment around the tank 21. The controller 5 is further configured to perform an environment-temperature analysis based on the environment-temperature signal, and to output to the machine tool 91 a result of the environment-temperature analysis that indicates the temperature of the environment around the tank 21. After the machine tool 91 receives the result of the environment-temperature analysis, the output device 913 is configured to express the temperature of the environment around the tank 21.

Moreover, the machine tool 91 is configured to determine a difference between the temperature of the machining fluid 94 stored in the tank 21 and the temperature of the environment around the tank 21 as a temperature difference, and to determine whether the temperature difference is in an abnormal-temperature range, a normal-temperature range, or a warning-temperature range between the abnormal-temperature range and the normal-temperature range. In this embodiment, the abnormal-temperature range covers temperatures that are not less than ten degrees Celsius; the warning-temperature range covers temperatures that are not less than six degrees Celsius but less than ten degrees Celsius; the normal-temperature range covers temperatures that are not less than three degrees Celsius but less than six degrees Celsius. The output device 913 is configured to express an abnormal-temperature indication indicating that the temperature of the machining fluid 94 stored in the tank 21 is abnormal when it is determined that the temperature difference is in the abnormal-temperature range. The output device 913 is configured to express a warning-temperature indication indicating that the temperature of the machining fluid 94 stored in the tank 21 is increased when it is determined that the temperature difference is in the warning-temperature range. The output device 913 is configured to express a normal-temperature indication indicating that the temperature of the machining fluid 94 stored in the tank 21 is normal when it is determined that the temperature difference is in the normal-temperature range.

In this embodiment, the ultrasonic sensor 23 is implemented by an ultrasonic range finder, and each of the first thermometer 24 and the second thermometer 25 is implemented by a DS18B20 digital thermometer, but implementations thereof are not limited to the disclosure herein and may vary in other embodiments. It is worth to note that, in some embodiments, the ultrasonic sensor 23 and the second thermometer 25 are integrated into a KS-103 ultrasonic sensor module that communicates with the controller 5 under an inter-integrated circuit (I²C) protocol. In addition, communication between the controller 5 and the first thermometer 24 follows a 1-Wire protocol.

The controller 5 is further configured to perform pump-current detection on three-phase electric power received by the pump 3, and to output to the machine tool 91 a result of the pump-current detection that indicates a current value of the three-phase electric power received by the pump 3. After the machine tool 91 receives the result of the pump-current detection, the output device 913 is configured to express the current value of the three-phase electric power received by the pump 3.

Moreover, the machine tool 91 is configured to determine whether the current value of the three-phase electric power received by the pump 3 is equal to zero, is in a high pump-current range, is in a medium-high pump-current range, is in a normal pump-current range, or is in a low pump-current range. It should be noted that the medium-high pump-current range and the normal pump-current range are between the high pump-current range and the low pump-current range. In this embodiment, the machine tool 91 is configured to determine that the current value of the three-phase electric power received by the pump 3 is in the high pump-current range when it is determined that the current value is not smaller than 5.0 A, is in the medium-high pump-current range when it is determined that the current value is not smaller than 4.0 A but smaller than 5.0 A, is in the normal pump-current range when it is determined that the current value is not smaller than 2.5 A but smaller than 4.0 A, and is in the low pump-current range when it is determined that the current value is greater than 0 A but smaller than 2.5 A. When it is determined that the current value of the three-phase electric power received by the pump 3 is equal to zero, the output device 913 is configured to express an abnormal pump-current indication indicating that the current value of the three-phase electric power received by the pump 3 is abnormal. When it is determined that the current value of the three-phase electric power received by the pump 3 is in the high pump-current range, the output device 913 is configured to express a high pump-current indication indicating that the current value of the three-phase electric power received by the pump 3 exceeds the normal pump-current range. When it is determined that the current value of the three-phase electric power received by the pump 3 is in the medium-high pump-current range, the output device 913 is configured to express a medium-high pump-current indication indicating that the current value of the three-phase electric power received by the pump 3 is slightly high. When it is determined that the current value of the three-phase electric power received by the pump 3 is in the normal pump-current range, the output device 913 is configured to express a normal pump-current indication indicating that the current value of the three-phase electric power received by the pump 3 is normal. When it is determined that the current value of the three-phase electric power received by the pump 3 is in the low pump-current range, the output device 913 is configured to express a low pump-current indication indicating that the current value of the three-phase electric power received by the pump 3 is below the normal pump-current range. Further, when it is determined that the current value of the three-phase electric power received by the pump 3 is equal to zero or is in the low pump-current range, the machine tool 91 is configured to stop the pump 3.

The controller 5 is further configured to perform remover-current detection on the three-phase electric power received by the chip remover 92 (i.e., received by the three-phase motor), and to output to the machine tool 91 a result of the remover-current detection that indicates a current value of the three-phase electric power received by the chip remover 92. After the machine tool 91 receives the result of the remover-current detection, the output device 913 is configured to express the current value of the three-phase electric power received by the chip remover 92.

Moreover, the machine tool 91 is configured to determine whether the current value of the three-phase electric power received by the chip remover 92 is equal to zero, is in a high remover-current range, is in a medium-high remover-current range, is in a normal remover-current range, or is in a low remover-current range. It should be noted that the medium-high remover-current range and the normal remover-current range are between the high remover-current range and the low remover-current range. In this embodiment, the machine tool 91 is configured to determine that the current value of the three-phase electric power received by the chip remover 92 is in the high remover-current range when it is determined that the current value is not smaller than 1.6 A, is in the medium-high remover-current range when it is determined that the current value is not smaller than 1.1 A but smaller than 1.6 A, is in the normal remover-current range when it is determined that the current value is not smaller than 0.5 A but smaller than 1.1 A, and is in the low remover-current range when it is determined that the current value is greater than 0 A but smaller than 0.5 A. When it is determined that the current value of the three-phase electric power received by the chip remover 92 is equal to zero, the output device 913 is configured to express an abnormal remover-current indication indicating that the current value of the three-phase electric power received by the chip remover 92 is abnormal. When it is determined that the value of the three-phase electric current received by the chip remover 92 is in the high remover-current range, the output device 913 is configured to express a high remover-current indication indicating that the value of the three-phase electric current received by the chip remover 92 exceeds the normal remover-current range. When it is determined that the value of the three-phase electric current received by the chip remover 92 is in the medium-high remover-current range, the output device 913 is configured to express a medium-high remover-current indication indicating that the value of the three-phase electric current received by the chip remover 92 is slightly high. When it is determined that the value of the three-phase electric current received by the chip remover 92 is in the normal remover-current range, the output device 913 is configured to express a normal remover-current indication indicating that the value of the three-phase electric current received by the chip remover 92 is normal. When it is determined that the value of the three-phase electric current received by the chip remover 92 is in the low remover-current range, the output device 913 is configured to express a low remover-current indication indicating that the value of the three-phase electric current received by the chip remover 92 is below the normal remover-current range. Further, when it is determined that the current value of the three-phase electric power received by the chip remover 92 is equal to zero or is in the low remover-current range, the machine tool 91 is configured to stop the chip remover 92.

It is worth to note that in this embodiment, the controller 5 utilizes, for each of the remover-current detection and the pump-current detection, three Allegro™ ACS718 current sensor ICs to perform said each of the remover-current detection and the pump-current detection.

In one embodiment, the controller 5 is further electrically connected to an electronic device 4. The electronic device 4 may be implemented to be a desktop computer, a laptop computer, a notebook computer, a tablet computer or a smartphone, but implementation thereof is not limited to what are disclosed herein and may vary in other embodiments. The electronic device 4 includes a display (not shown) that may be implemented by an LCD, an LED display, a plasma display panel, a projection display or the like. The controller 5 is further configured to output to the electronic device 4 the result of the liquid-level analysis, the result of the liquid-temperature analysis, the result of the environment-temperature analysis, the result of the pump-current detection and the result of the remover-current detection. After the electronic device 4 receives one of the result of the liquid-level analysis, the result of the liquid-temperature analysis, the result of the environment-temperature analysis, the result of the pump-current detection and the result of the remover-current detection, the display of the electronic device 4 is configured to express the corresponding one of the level of the machining fluid 94 stored in the tank 21, the temperature of the machining fluid 94 stored in the tank 21, the temperature of the environment around the tank 21, the current value of the three-phase electric power received by the pump 3, and the current value of the three-phase electric power received by the chip remover 92. It is worth to note that in this embodiment, the controller 5 and the electronic device 4 communicate with each other by using Bluetooth® technology, but is not limited thereto.

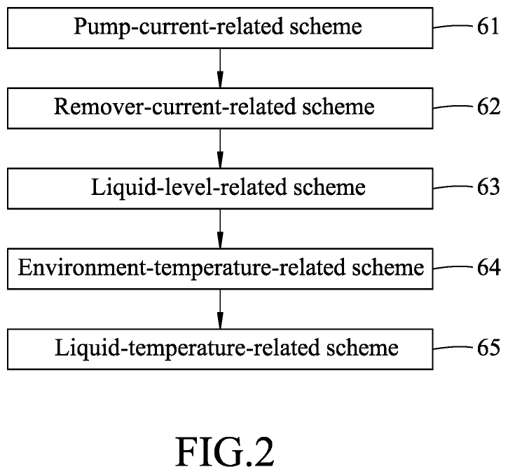

FIGS. 2 to 5 cooperatively illustrate an embodiment of an operation method of the machine tool system previously described. The operation method includes a first procedure, a second procedure, a third procedure and a fourth procedure. The first procedure is executed for one time upon the machine tool system being powered on. After the first procedure, the second procedure is repeatedly and continuously executed. While the second procedure is being repeatedly and continuously executed, the third procedure is repeatedly executed for every first predetermined time interval (e.g., four minutes). Moreover, while the second procedure is being repeatedly and continuously executed, the fourth procedure is repeatedly executed for every second predetermined time interval (e.g., five minutes), wherein the second predetermined time interval is longer than the first predetermined time interval.

Referring to FIG. 2, an embodiment of the first procedure is illustrated. In the first procedure, a pump-current-related scheme 61, a remover-current-related scheme 62, a liquid-level-related scheme 63, an environment-temperature-related scheme 64 and a liquid-temperature-related scheme 65 are sequentially performed in order.

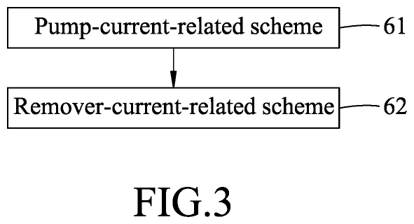

Referring to FIG. 3, an embodiment of the second procedure is illustrated. In the second procedure, the pump-current-related scheme 61 and the remover-current-related scheme 62 are sequentially performed in order.

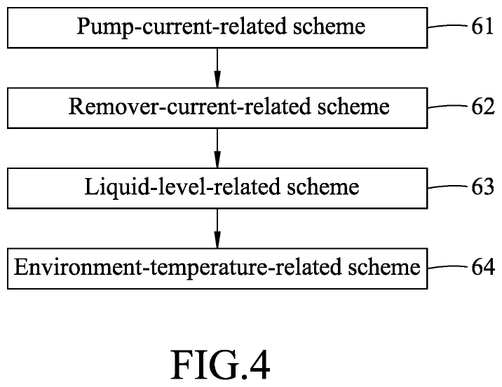

Referring to FIG. 4, an embodiment of the third procedure is illustrated. In the third procedure, the pump-current-related scheme 61, the remover-current-related scheme 62, the liquid-level-related scheme 63 and the environment-temperature-related scheme 64 are sequentially performed in order.

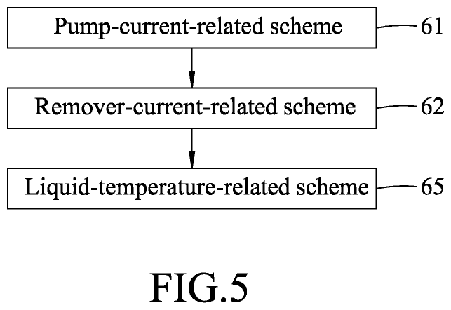

Referring to FIG. 5, an embodiment of the fourth procedure is illustrated. In the fourth procedure, the pump-current-related scheme 61, the remover-current-related scheme 62 and the liquid-temperature-related scheme 65 are sequentially performed in order.

It is worth to note that the operation method of the machine tool system are implemented by coding in a computer programming language (e.g., G-code). The order of executing the pump-current-related scheme 61, the remover-current-related scheme 62, the liquid-level-related scheme 63, the environment-temperature-related scheme 64 and the liquid-temperature-related scheme 65 may vary in other embodiments. In some embodiments, the pump-current-related scheme 61, the remover-current-related scheme 62, the liquid-level-related scheme 63, the environment-temperature-related scheme 64 and the liquid-temperature-related scheme 65 are independently executed in parallel.

Next, details of each of the pump-current-related scheme 61, the remover-current-related scheme 62, the liquid-level-related scheme 63, the environment-temperature-related scheme 64 and the liquid-temperature-related scheme 65 will be described.

In the pump-current-related scheme 61, the controller 5 performs the pump-current detection on the three-phase electric power received by the pump 3, and outputs the result of the pump-current detection to the machine tool 91. In response to receipt of the result of the pump-current detection, the machine tool 91 determines whether the current value of the three-phase electric power received by the pump 3 is equal to zero, is in the high pump-current range, is in the normal pump-current range, or is in the low pump-current range, and according to the determination made by the machine tool 91, the output device 913 expresses the corresponding one of the high pump-current indication, the normal pump-current indication, the low pump-current indication and the abnormal pump-current indication. It should be noted that the machine tool 91 stops the pump when it is determined that the current value of the three-phase electric power received by the pump 3 is equal to zero or is in the low pump-current range.

In the remover-current-related scheme 62, the controller 5 performs the remover-current detection on the three-phase electric power received by the chip remover 92, and outputs the result of the remover-current detection to the machine tool 91. In response to receipt of the result of the remover-current detection, the machine tool 91 determines whether the current value of the three-phase electric power received by the chip remover 92 is equal to zero, is in the high remover-current range, is in the normal remover-current range, or is in the low remover-current range, and according to the determination made by the machine tool 91, the output device 913 expresses the corresponding one of the high remover-current indication, the normal remover-current indication, the low remover-current indication and the abnormal remover-current indication. It should be noted that the machine tool 91 stops the chip remover 92 when it is determined that the current value of the three-phase electric power received by the chip remover 92 is equal to zero or is in the low remover-current range.

In the liquid-level-related scheme 63, the ultrasonic sensor 23 measures the distance to the surface of the machining fluid 94 stored in the tank 21, and outputs the distance signal to the controller 5 based on measurement of the distance. In response to receipt of the distance signal from the ultrasonic sensor 23, the controller 5 performs the liquid-level analysis based on the distance signal, and outputs the result of the liquid-level analysis to the machine tool 91. In response to receipt of the result of the liquid-level analysis, the output device 913 expresses one of the high liquid-level indication, the medium liquid-level indication, the low liquid-level indication and the zero liquid-level indication that corresponds to one of the high liquid level, the medium liquid level, the low liquid level and the zero liquid level at which the machining fluid 94 stored in the tank 21 is determined to be. Additionally, when it is determined that the machining fluid 94 stored in the tank 21 is at one of the zero liquid level and the low liquid level, the machine tool 91 stops the pump 3.

In the liquid-temperature-related scheme 64, the first thermometer 24 detects the temperature of the machining fluid 94 stored in the tank 21, and outputs the liquid-temperature signal to the controller 5 based on detection of the temperature of the machining fluid 94. The controller 5 performs the liquid-temperature analysis based on the liquid-temperature signal, and outputs the result of the liquid-temperature analysis to the machine tool 91.

In the environment-temperature-related scheme 65, the second thermometer 25 detects the temperature of the environment around the tank 21, and outputs the environment-temperature signal to the controller 5 based on detection of the temperature of the environment around the tank 21. The controller 5 performs the environment-temperature analysis based on the environment-temperature signal, and outputs the result of the environment-temperature analysis to the machine tool 91.

In response to receipt of both of the result of the liquid-temperature analysis and the result of the environment-temperature analysis, the output device 913 expresses one of the abnormal-temperature indication, the warning-temperature indication and the normal-temperature indication that corresponds to one of the abnormal-temperature range, the normal-temperature range and the warning-temperature range in which the temperature difference is determined to be.

To sum up, for the machine tool system according to the disclosure, the ultrasonic sensor 23 and the controller 5 cooperatively generate the result of the liquid-level analysis that indicates the level of the machining fluid 94 stored in the tank 21, and the machine tool 91 stops the pump 3 when it is determined that the level of the machining fluid 94 stored in the tank 21 is less than the predetermined level. In this way, supply of the machining fluid 94 may be stable. Moreover, in the operation method of the machine tool system, the pump-current-related scheme 61, the remover-current-related scheme 62, the liquid-level-related scheme 63, the environment-temperature-related scheme 64 and the liquid-temperature-related scheme 65 are scheduled to timely reflect a variety of conditions of the machine tool system, so that an operator of the machine tool system may be able to be notified straight away when any abnormal condition occurs.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A detecting system for detecting a level of machining fluid to be supplied to a machine tool, the machine tool being used to machine a workpiece and including a nozzle, said detecting system comprising:
a tank unit including
a tank that is configured to store machining fluid, and
an ultrasonic sensor that is disposed on said tank, and that is configured to measure a distance to a surface of the machining fluid stored in said tank and to output a distance signal based on measurement of the distance;
a pump disposed on said tank, adapted to be connected to the nozzle, and configured to pump the machining fluid from said tank to the nozzle for spraying the machining fluid on the workpiece; and
a controller electrically connected to the machine tool, said ultrasonic sensor and said pump, and configured to receive the distance signal, to perform a liquid-level analysis based on the distance signal, and to output to the machine tool a result of the liquid-level analysis that includes a level of the machining fluid stored in said tank.

2. The detecting system as claimed in claim 1, wherein:
said tank unit further includes a first thermometer that is electrically connected to said controller, that is disposed on said tank, and that is configured to detect a temperature of the machining fluid stored in said tank, and to output to said controller a liquid-temperature signal based on detection of the temperature of the machining fluid; and
said controller is further configured to perform a liquid-temperature analysis based on the liquid-temperature signal, and to output to the machine tool a result of the liquid-temperature analysis that indicates the temperature of the machining fluid stored in said tank.

3. The detecting system as claimed in claim 1, wherein:
said tank unit further includes a second thermometer that is electrically connected to said controller, that is disposed on said tank, and that is configured to detect a temperature of environment around said tank, and to output an environment-temperature signal to said controller based on detection of the temperature of the environment around said tank; and
said controller is further configured to perform an environment-temperature analysis based on the environment-temperature signal, and to output to the machine tool a result of the environment-temperature analysis that indicates the temperature of the environment around said tank.

4. The detecting system as claimed in claim 1, wherein said controller is further configured to perform pump-current detection on three-phase electric power received by said pump, and to output to the machine tool a result of the pump-current detection that indicates a current value of the three-phase electric power received by said pump.

5. The detecting system as claimed in claim 1, adapted to cooperate with a chip remover for removing chips from said tank,
wherein said controller is further electrically connected to the chip remover, and is further configured to perform remover-current detection on three-phase electric power received by the chip remover, and to output to the machine tool a result of the remover-current detection that indicates a current value of the three-phase electric power received by the chip remover.

6. A machine tool system, comprising:
a tank unit including a tank that is configured to store machining fluid, and an ultrasonic sensor that is disposed on said tank and that is configured to measure a distance to a surface of the machining fluid stored in said tank and to output a distance signal based on measurement of the distance;
a machine tool configured to machine a workpiece, and including a nozzle that is configured to spray the machining fluid on the workpiece;
a pump disposed on said tank, connected to said nozzle, and configured to pump the machining fluid from said tank to said nozzle for spraying the machining fluid on the workpiece; and
a controller electrically connected to said machine tool, said ultrasonic sensor and said pump, and configured to receive the distance signal from said ultrasonic sensor, to perform a liquid-level analysis based on the distance signal, and to output to said machine tool a result of the liquid-level analysis that includes a level of the machining fluid stored in said tank,
wherein said machine tool is configured to determine whether the level of the machining fluid stored in said tank is less than a predetermined level, and to stop said pump when it has determined that the level of the machining fluid stored in said tank is less than the predetermined level.

7. The machine tool system as claimed in claim 6, wherein:
said machine tool further includes an output device; and
said output device is configured to express the level of the machining fluid stored in said tank.

8. The machine tool system as claimed in claim 7, wherein:
said machine tool is further configured to determine, according to the distance between said ultrasonic sensor and the surface of the machining fluid stored in said tank included in the result of the liquid-level analysis, whether the machining fluid stored in said tank is at a high liquid level, a medium liquid level, a low liquid level or a zero liquid level;
when it is determined that the machining fluid stored in said tank is at the zero liquid level, said output device is configured to express a zero-liquid-level indication indicating that the machining fluid stored in said tank is at the zero liquid level;
when it is determined that the machining fluid stored in said tank is at the low liquid level, said output device is configured to express a low-liquid-level indication indicating that the machining fluid stored in said tank is at the low liquid level;
when it is determined that the machining fluid stored in said tank is at the medium liquid level, said output device is configured to express a medium-liquid-level indication indicating that the machining fluid stored in said tank is at the medium liquid level; and
when it is determined that the machining fluid stored in said tank is at the high liquid level, said output device is configured to express a high-liquid-level indication indicating that the machining fluid stored in said tank is at the high liquid level.

9. The machine tool system as claimed in claim 8, wherein said machine tool is configured to stop said pump when it is determined that the machining fluid stored in said tank is at the low liquid level or the zero liquid level.

10. An operation method of a machine tool system that includes a machine tool for machining a workpiece and including a nozzle, a tank storing machining fluid, an ultrasonic sensor disposed on the tank, a first thermometer disposed in the tank, a second thermometer disposed on the tank, a pump disposed on the tank for pumping the machining fluid from the tank to the nozzle for spraying the machining fluid on the workpiece, a chip remover for removing chips from the tank, and a controller that is electrically connected to the machine tool, the chip remover, the ultrasonic sensor, the first thermometer, the second thermometer and the pump, the method comprising:
a pump-current-related scheme including steps of
the controller performing pump-current detection on three-phase electric power received by the pump, and outputting to the machine tool a result of the pump-current detection that indicates a current value of the three-phase electric power received by the pump;
a remover-current-related scheme including steps of
the controller performing remover-current detection on three-phase electric power received by the chip remover, and outputting to the machine tool a result of the remover-current detection that indicates a current value of the three-phase electric power received by the chip remover;
a liquid-level-related scheme including steps of
the ultrasonic sensor measuring a distance to a surface of the machining fluid stored in the tank, and outputting a distance signal based on measurement of the distance, and
the controller receiving the distance signal from the ultrasonic sensor, performing a liquid-level analysis based on the distance signal, and outputting to the machine tool a result of the liquid-level analysis that includes a level of the machining fluid stored in the tank;
a liquid-temperature-related scheme including steps of
the first thermometer detecting a temperature of the machining fluid stored in the tank, and outputting to the controller a liquid-temperature signal based on detection of the temperature of the machining fluid, and
the controller performing a liquid-temperature analysis based on the liquid-temperature signal, and outputting to the machine tool a result of the liquid-temperature analysis that indicates the temperature of the machining fluid stored in the liquid tank; and
an environment-temperature-related scheme including steps of
the second thermometer detecting a temperature of environment around the tank, and outputting to the controller an environment-temperature signal based on detection of the temperature of environment around the tank, and
the controller performing an environment-temperature analysis based on the environment-temperature signal, and outputting to the machine tool a result of the environment-temperature analysis that indicates the temperature of the environment around the liquid tank.

11. The operation method as claimed in claim 10, the machine tool further including an output device, wherein the pump-current-related scheme further includes steps of:
the machine tool determining whether the current value of the three-phase electric power received by the pump is equal to zero, is in a high pump-current range, is in a normal pump-current range, or is in a low pump-current range;
when it is determined that the current value of the three-phase electric power received by the pump is equal to zero, the output device expressing an abnormal pump-current indication indicating that the current value of the three-phase electric power received by the pump is abnormal, and the machine tool stopping the pump;
when it is determined that the current value of the three-phase electric power received by the pump is in the high pump-current range, the output device expressing a high pump-current indication indicating that the current value of the three-phase electric power received by the pump exceeds the normal pump-current range;
when it is determined that the current value of the three-phase electric power received by the pump is in the normal pump-current range, the output device expressing a normal pump-current indication indicating that the current value of the three-phase electric power received by the pump is normal; and
when it is determined that the current value of the three-phase electric power received by the pump is in the low pump-current range, the output device expressing a low pump-current indication indicating that the current value of the three-phase electric power received by the pump is below the normal pump-current range.

12. The operation method as claimed in claim 10, the machine tool further including an output device, wherein the remover-current-related scheme further includes steps of:
the machine tool determining whether the current value of the three-phase electric power received by the chip remover is equal to zero, is in a high remover-current range, is in a normal remover-current range, or is in a low remover-current range;
when it is determined that the current value of the three-phase electric power received by the chip remover is equal to zero, the output device expressing an abnormal remover-current indication indicating that the current value of the three-phase electric power received by the chip remover is abnormal, and the machine tool stopping the chip remover;
when it is determined that the value of the three-phase electric current received by the chip remover is in the high remover-current range, the output device expressing a high remover-current indication indicating that the value of the three-phase electric current received by the chip remover exceeds the normal remover-current range;
when it is determined that the value of the three-phase electric current received by the chip remover is in the normal remover-current range, the output device expressing a normal remover-current indication indicating that the value of the three-phase electric current received by the chip remover is normal; and
when it is determined that the value of the three-phase electric current received by the chip remover is in the low remover-current range, the output device expressing a low remover-current indication indicating that the value of the three-phase electric current received by the chip remover is below the normal remover-current range.

13. The operation method as claimed in claim 10, the machine tool further including an output device, wherein the liquid-level-related scheme further includes steps of:
the machine tool determining, according to the distance between the ultrasonic sensor and the surface of the machining fluid stored in the tank included in the result of the liquid-level analysis, whether the machining fluid stored in the tank is at a high liquid level, a medium liquid level, a low liquid level or a zero liquid level;
when it is determined that the machining fluid stored in the tank is at the zero liquid level, the output device expressing a zero liquid-level indication indicating that the machining fluid stored in the tank is at the zero liquid level;
when it is determined that the machining fluid stored in the tank is at the low liquid level, the output device expressing a low liquid-level indication indicating that the machining fluid stored in the tank is at the low liquid level;
when it is determined that the machining fluid stored in the tank is at the medium liquid level, the output device expressing a medium liquid-level indication indicating that the machining fluid stored in the tank is at the medium liquid level;
when it is determined that the machining fluid stored in the tank is at the high liquid level, the output device expressing a high liquid-level indication indicating that the machining fluid stored in the tank is at the high liquid level; and
when it is determined that the machining fluid stored in the tank is at one of the zero liquid level and the low liquid level, the machine tool stopping the pump.

14. The operation method as claimed in claim 10, the machine tool further including an output device, further comprising:
the machine tool determining a difference between the temperature of the machining fluid stored in the tank and the temperature of environment around the tank as a temperature difference;
the machine tool determining whether the temperature difference is in an abnormal-temperature range, a normal-temperature range, or a warning-temperature range between the abnormal-temperature range and the normal-temperature range;
the output device expressing an abnormal-temperature indication indicating that the temperature of the machining fluid stored in the tank is abnormal when it is determined that the temperature difference is in the abnormal-temperature range;
the output device expressing a warning-temperature indication indicating that the temperature of the machining fluid stored in the tank is increased when it is determined that the temperature difference is in the warning-temperature range; and
the output device expressing a normal-temperature indication indicating that the temperature of the machining fluid stored in the tank is normal when it is determined that the temperature difference is in the normal-temperature range.

15. The operation method as claimed in claim 10, the method further comprising a step of executing a first procedure for one time upon the machine tool system being powered on, the first procedure including:
sequentially performing the pump-current-related scheme, the remover-current-related scheme, the liquid-level-related scheme, the environment-temperature-related scheme and the liquid-temperature-related scheme in order.

16. The operation method as claimed in claim 15, the method further comprising a step of, after the first procedure, repeatedly and continuously executing a second procedure that includes:
sequentially performing the pump-current-related scheme and the remover-current-related scheme in order.

17. The operation method as claimed in claim 16, the method further comprising a step of, while implementing the step of repeatedly and continuously executing the second procedure, repeatedly executing, for every first predetermined time interval, a third procedure that includes:
sequentially performing the pump-current-related scheme, the remover-current-related scheme, the liquid-level-related scheme and the environment-temperature-related scheme in order.

18. The operation method as claimed in claim 17, the method further comprising a step of, while implementing the step of repeatedly and continuously executing the second procedure, repeatedly executing, for every second predetermined time interval that is greater than the first predetermined time interval, a fourth procedure that includes:
sequentially performing the pump-current-related scheme, the remover-current-related scheme and the liquid-temperature-related scheme in order.
